(19) United States
(12) Patent Application Publication
(10) Pub. No.: US 2012/0045716 A1
(43) Pub. Date: Feb. 23, 2012

(54) DEVELOPING AGENT AND IMAGE FORMING APPARATUS

(75) Inventor: Yosuke Imamura, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/214,362

(22) Filed: Aug. 22, 2011

Related U.S. Application Data
(60) Provisional application No. 61/376,022, filed on Aug. 23, 2010.

(51) Int. Cl. G03G 9/00; G03G 15/08

(52) U.S. Cl. 430/105; 430/108.7; 399/252

(57) ABSTRACT

According to one embodiment, a developing agent includes a toner particle containing a binder resin and a coloring agent, and additives added onto the surface of the toner particle. The additives contain a silica fine particle having an average circularity of 0.90 or more. In the additives existing on the surface of the toner particle, an existence ratio of an additive having a minor axis a of a primary particle diameter falling within the range of from 30 nm to 70 nm is 70% or more.

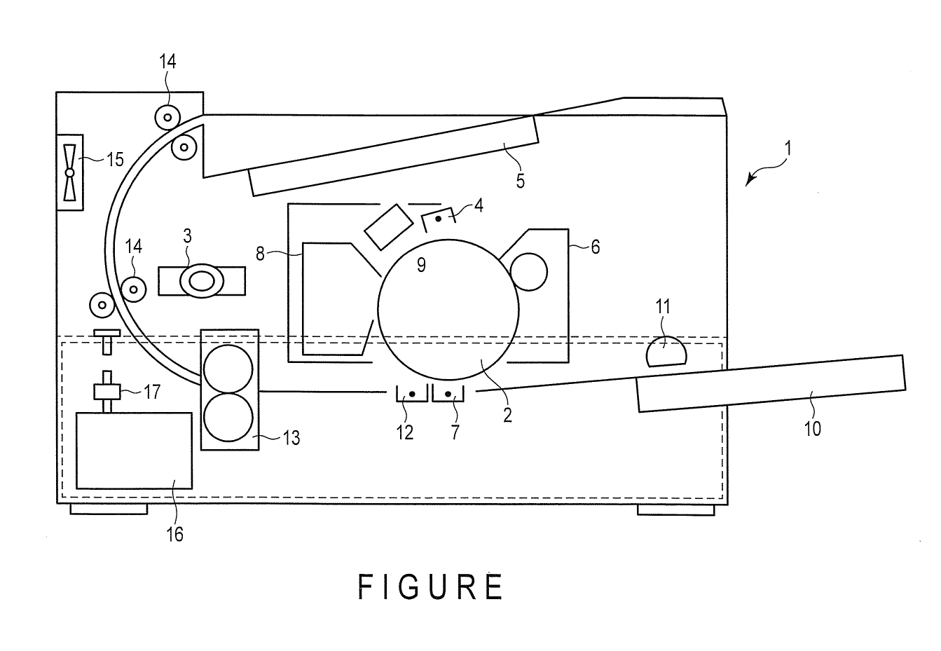

### CROSS-REFERENCE TO RELATED APPLICATIONS

This application is based upon and claims the benefit of priority from U.S. Provisional Application No. 61/376,022, filed on Aug. 23, 2010; the entire contents of which are incorporated herein by reference.

### FIELD

Embodiments described herein relate generally to a developing agent and an image forming apparatus.

### BACKGROUND

In view of a trend of conservation of energy in consideration of the environment, there are made a large number of investigations regarding low-temperature fixation of a toner. The low-temperature fixation of a toner can be achieved by using, for example, a resin having a low melting point as a binder resin which occupies the majority of toner constituent materials.

However, in the resin having a low melting point, its viscosity at melt kneading tends to become low, a shearing force applied to a kneaded material is lowered as compared with that in the related art, and dispersibility of the material is deteriorated. In such a toner, since its charge site is non-uniform, the chargeability was ensured by covering the toner surface with a granular additive. But, an aggregated material such as fused silica is frequently used as the conventional additive, and it is difficult to uniformly disperse such an additive, so that the additive tends to be interspersed on the toner surface. As a result, there is involved such a problem that lack of uniformity of a charged amount distribution due to deterioration of startup of charge occurs, thereby causing in-machine contamination such as toner scattering or image failure such as ground fogging.

### BRIEF DESCRIPTION OF THE DRAWINGS

FIGURE is an exemplary view showing an image forming apparatus using a developing agent according to an embodiment.

### DETAILED DESCRIPTION

In general, according to one embodiment, the developing agent includes a toner particle containing a binder resin and a coloring agent and additives added onto the surface of the toner particle. At least a silica fine particle having an average circularity of 0.90 or more is used as additives. In additives existing on the surface of the toner particle, an existence ratio of the additive having a minor axis a of a primary particle diameter falling within the range of from 30 nm to 70 nm is 70% or more.

In order to achieve a calculation method of formula (1), first of all, the analysis can be carried out by incorporating a toner containing a toner particle and additives added onto the surface of the toner particle, such as a silica fine particle, as an SEM image and using an image analysis software. The magnification of visual field can be made 50,000 times. Also, the analysis can be carried out by using an image in which 20 particles at minimum can be confirmed in terms of the number of particles subject to the measurement. In such a way, by measuring the number X of particles in which the minor axis a of a primary particle diameter falls within the range of from 30 nm to 70 nm and the number Y of particles in which the minor axis a of a primary particle diameter falls outside the foregoing range, the existence ratio (%) on the toner particle can be calculated according to the following formula (1).

Existence ratio (%)=x/(X+Y)×100 (1)

Also, the average circularity can be calculated according to the following formula (2).

Average circularity=Σ(m1+m2 . . . +mn)/n (2)

In the foregoing formula (2), m and n are defined as follows.

m represents a length of the circumference of a circle having the same projected area as that of a particle projected image relative to a length of the periphery of the particle projected image.

n represents the number of particles measured on the image and is 20 or more.

As the silica fine particle, a silica fine particle formed by the sol-gel method can be used. The sol-gel derived silica fine particle, hereinafter referred to as “medium particle size silica fine particle”, is one which is monodispersed and whose surface is hydrophobilized, and its average primary particle diameter is from 30 to 80 nm, and preferably from 40 to 60 nm. Also, the circularity of the silica fine particle having such a particle diameter ranges from 0.8 to 1, and preferably from 0.90 to 1.

In accordance with the developing agent according to the exemplary embodiment, if the medium particle size silica fine particle which is monodispersed and which has a high circularity is added to a toner mother particle which is made to have a low melting point, it is possible to reveal quick startup properties of charge and to make both low-temperature fixation and high image quality over a long period of time compatible with each other. As to a reason for this, it may be considered that this is caused due to the matter that if the medium particle size silica fine particle has adequate particle diameter and particle size distribution and is monodispersed on the toner mother particle surface, in view of the fact that the medium particle size silica fine particle uniformly covers the toner surface, and coupled with its high circularity, quick startup of charge is realized. Also, as to the medium particle size silica fine particle having a high circularity, for example, if it is applied to a toner particle having a fixing temperature of from about 135° C. to 175° C., there was a tendency that an adhesion onto the toner surface is small, so that the charged amount distribution becomes non-uniform in a long life. However, in a combination with a low-temperature fixing toner having a low viscosity and a fixing temperature of from about 120° C. to 160° C., since immobilization properly proceeds, a good adhesion is obtained, and it becomes possible to realize a long life more than ever. Incidentally, if the particle size of the medium particle size silica fine particle is more uniform, an effect for improving chargeability becomes conspicuous. This is because if the particle size is non-uniform, just a part of large particle size silica fine particles comes into contact with a carrier, or small particle size silica hides in large particle size silica, whereby the medium particle size silica fine particle does not effectively function.

The sol-gel derived silica as referred to herein means one prepared by hydrophobilizing the surface of a sol-gel derived silica core having an average primary particle diameter of from 40 to 60 nm, which is obtainable from a silica sol suspension obtained by hydrolysis and condensation reaction of an alkoxysilane in an organic solvent where water is present in the presence of a catalyst by means of a known sol-gel method for carrying out solvent removal, drying and granulation. Meanwhile, the fused silica as referred to herein means one prepared by fusing pulverized silica stone at a high temperature, for example, about 2,000° C. and making the fused silica stone spherical utilizing a surface tension. As compared with the fused silica, the sol-gel derived silica has a high circularity and is hardly aggregated.

In the developing agent according to the exemplary embodiment, an addition amount of the sol-gel derived silica is preferably from 0.1 to 3.0% by weight, and more preferably from 0.5 to 2.0% by weight relative to the total weight of the toner particle.

In the developing agent according to the exemplary embodiment, by adding at least one kind of the sol-gel derived silica fine particle as additives onto the surface of the toner particle, charge characteristics become good, a long life can be realized, and fixing offset properties become good.

Also, for the purpose of achieving fluidity impartation or charge control, an inorganic oxide fine particle other than the sol-gel derived silica fine particle can be added as one of additives onto the surface of the toner particle. If desired, this inorganic oxide fine particle can be hydrophobilized. Also, it is possible to add an inorganic fine particle or a resin fine particle as an abrasive or a cleaning aid. Of such other additives, a hydrophobilized titanium oxide fine particle having a volume average primary particle diameter of from 10 to 50 nm is preferably used because it is able to make toner charge environmental difference small. The volume average primary particle diameter of the titanium oxide fine particle is preferably from 10 to 30 nm. An addition amount of the titanium oxide fine particle is at least from 0.1 to 2.0% by weight, and preferably from 0.5 to 1.5% by weight relative to the total weight of the toner particle. If the volume average primary particle diameter of the titanium oxide fine particle exceeds 50 nm, there is a tendency that charge injection is easy to occur. Also, if the volume average primary particle diameter of the titanium oxide fine particles is less than 10 nm, dispersion into the toner tends to become insufficient.

Furthermore, for the purpose of achieving charge adjustment or fluidity impartation, an inorganic oxide fine particle may be added. An addition amount of the inorganic oxide fine particle can be set to from 0.1 to 3.0% by weight. Examples of such an inorganic oxide fine particle include zinc oxide, zinc stearate, alumina and silica.

The developing agent according to the exemplary embodiment may have a softening point of from 90 to 110° C.

The developing agent according to the exemplary embodiment may have a volume average particle diameter of from 4.0 to 10.0 μm.

As materials constituting the toner particle of the developing agent according to the exemplary embodiment, known materials can be used.

As the binder resin, a polyester resin can be used.

As raw material monomers of the polyester, a dihydric or more-hydric alcohol component and a divalent or more-valent carboxylic acid component such as carboxylic acids, carboxylic acid anhydrides and carboxylic acid esters can be used.

Examples of the dihydric alcohol component include alkylene oxides of bisphenol A, such as polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane and polyoxypropylene(6)-2,2-bis(4-hydroxyphenyl)propane, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A and hydrogenated bisphenol A.

The dihydric alcohol component is preferably a bisphenol A-alkylene (carbon number: 2 or 3) oxide adduct (average addition molar number: 1 to 10), ethylene glycol, propylene glycol, 1,6-hexanediol, bisphenol A or hydrogenated bisphenol A.

Examples of the trihydric or more-hydric alcohol component include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane and 1,3,5-trihydroxymethylbenzene.

The trihydric or more-hydric alcohol component is preferably sorbitol, 1,4-sorbitan, pentaerythritol, glycerol or trimethylolpropane.

In the exemplary embodiment, such dihydric alcohols or trihydric or more-hydric alcohols can be used solely or in combination of plural kinds thereof. In particular, it is preferable to use, as a main component, a bisphenol A-alkylene (carbon number: 2 or 3) oxide adduct (average addition molar number: 1 to 10).

Examples of the divalent carboxylic acid component include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, alkenylsuccinic acids such as n-dodecenylsuccinic acid, alkylsuccinic acids such as n-dodecylsuccinic acid, and anhydrides or lower alkyl esters of these acids.

The divalent carboxylic acid component is preferably maleic acid, fumaric acid, terephthalic acid, or succinic acid substituted with an alkenyl group having from 2 to 20 carbon atoms.

Examples of the trivalent or more-valent carboxylic acid component include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Empol trimer acid, and acid anhydrides or lower alkyl esters thereof.

The trivalent or more-valent carboxylic acid component is preferably 1,2,4-benzenetricarboxylic acid (trimellitic acid) or an acid anhydride or alkyl (carbon number: 1 to 12) ester thereof.

In the exemplary embodiment, such divalent carboxylic acids or trivalent or more-valent carboxylic acids can be used solely or in combination of plural kinds thereof. In particular, it is preferable to use, as a main component, fumaric acid, terephthalic acid, or succinic acid substituted with an alkenyl group having from 2 to 20 carbon atoms, each of which is the divalent carboxylic acid component; or 1,2,4-benzenetricarboxylic acid (trimellitic acid) or an acid anhydride or alkyl (carbon number: 1 to 12) ester thereof, each of which is the trivalent or more-valent carboxylic acid component.

In order to accelerate the reaction at the polymerization of raw material monomers of the polyester, a usually used catalyst such as dibutyltin oxide, a titanium compound, a dialkoxytin(II), tin(II) oxide, a fatty acid tin(II), tin(II) dioctanoate and tin(II) distearate may be properly used.

As a wax which is used in the exemplary embodiment, a wax synthesized from a long-chain alkylcarboxylic acid and a long-chain alkyl alcohol component is used. Though an addition amount of the wax is not particularly limited, it is preferably from 3 to 17 parts by weight based on 100 parts by weight of the binder resin.

Examples of an acid component of a crystalline polyester resin which is used in the exemplary embodiment include adipic acid, oxalic acid, malonic acid, maleic acid, fumaric acid, citraconic acid, itaconic acid, glutaconic acid, succinic acid, phthalic acid, isophthalic acid, terephthalic acid, sebacic acid, azelaic acid, n-dodecylsuccinic acid, n-dodecenylsuccinic acid, cyclohexanedicarboxylic acid, trimellitic acid, pyromellitic acid, and acid anhydrides or alkyl (carbon number: 1 to 3) esters thereof. Of these, fumaric acid is preferable. Examples of an alcohol component include ethylene glycol, 1,2-propylene glycol, 1,3-propylene glycol, 1,4-butanediol, 1,5-pentanediol, 1,6-hexanediol, neopentyl glycol, 1,4-butenediol, polyoxypropylene, polyoxyethylene, glycerin, pentaerythritol and trimethylolpropane. Of these, 1,4-butanediol or 1,6-hexanediol is preferable.

An amount of the crystalline polyester resin is preferably from 3 to 35 parts by weight based on 100 parts by weight of the binder resin.

The crystalline polyester resin as referred to in the exemplary embodiment means one having a ratio of softening point and melting temperature (softening point/melting temperature) of from 0.9 to 1.1.

The crystalline polyester resin which is used in the exemplary embodiment preferably has a melting point of from 100 to 120° C.

As the coloring agent which is used in the exemplary embodiment, carbon black or organic or inorganic pigments or dyes, all of which are used for a color tone application, can be used.

Examples of the carbon black include acetylene black, furnace black, thermal black, channel black and ketjen black.

Also, examples of the pigment or dye include Fast Yellow G, Benzidine Yellow, Indo Fast Orange, Irgazin Red, Carmine FB, Permanent Bordeaux FRR, Pigment Orange R, Lithol Red 2G, Lake Red C, Rhodamine FB, Rhodamine B Lake, Phthalocyanine Blue, Pigment Blue, Brilliant Green B, Phthalocyanine Green and quinacridone.

These materials can be used solely or in admixture. Also, though an addition amount of the coloring agent is not particularly limited, it is preferably from 4 to 15 parts by weight based on 100 parts by weight of the binder resin.

As a charge control agent which is used in the exemplary embodiment, for example, a metal-containing azo compound is used. The metal-containing azo compound is desirably a complex or a complex salt in which a metal element thereof is iron, cobalt or chromium, or a mixture thereof.

Also, a metal-containing salicylic acid derivative compound or a metal oxide hydrophobilized material is useful as the charge control agent which is used in the exemplary embodiment. A complex or a complex salt in which a metal element thereof is zirconium, zinc, chromium or boron, or a mixture thereof is desirable. A clathrate compound of polysaccharide containing aluminum and magnesium is more desirable. Though an addition amount of the charge control agent is not particularly limited, it is preferably from 0.5 to 3 parts by weight based on the 100 parts by weight of the binder resin.

As to a mechanism for mixing and dispersing the raw materials, examples of a mixer include a Henschel mixer (manufactured by Mitsui Mining Company, Limited.); a super mixer (manufactured by Kawata Mfg., Co., Ltd.); Ribocone (manufactured by Okawara Mfg., Co., Ltd.); a nauta mixer, a turbulizer and a cyclomixer (all of which are manufactured by Hosokawa Micron Corporation); a spiral pin mixer (manufactured by Pacific Machinery & Engineering Co., Ltd.); and a Loedige mixer (manufactured by Matsubo Corporation). Examples of a kneader include a KRC kneader (manufactured by Kurimoto, Ltd.); a Buss Co-kneader (manufactured by Buss); a TEM type extruder (manufactured by Toshiba Machine Co., Ltd.); a TEX twin-screw kneader (manufactured by The Japan Steel Works, Ltd.); a PCM kneader (manufactured by Ikegai, Ltd.); a three-roll mill, a mixing roll mill and a kneader (all of which are manufactured by Inoue Mfg., Inc.); Kneadex (manufactured by Mitsui Mining Company, Limited.); an MS type pressure kneader and a kneader-ruder (all of which are manufactured by Moriyama Company Ltd.); and a Banbury mixer (manufactured by manufactured by Kobe Steel, Ltd.).

Also, as a mechanism for coarsely pulverizing the mixture, for example, a hammer mill, a cutter mill, a jet mill, a roller mill, a ball mill, etc. can be used. Also, examples of a pulverizer as a mechanism for finely pulverizing the coarsely pulverized material include a counterjet mill, Micronjet and Inomizer (all of which are manufactured by Hosokawa Micron Corporation); an IDS type mill and a PJM jet pulverizer (all of which are manufactured by Nippon Pneumatic Mfg. Co., Ltd.); Crossjet Mill (manufactured by Kurimoto, Ltd.); Ulmax (manufactured by Nisso Engineering Co., Ltd.); SK Jet-O-Mill (manufactured by Seisin Enterprise Co., Ltd.); Cliptron (manufactured by Kawasaki Heavy Industries, Ltd.); and Turbo Mill (manufactured by Turbo Kogyo Co., Ltd.).

Also, examples of a classifier for classifying the finely pulverized material include Classiel, Micron Classifier and Spedic Classifier (all of which are manufactured by Seisin Enterprises Co., Ltd.); Turbo Classifier (manufactured by Nisshin Engineering Co., Ltd.); Micron separator, Turboplex (ATP) and TSP Separator (all of which are manufactured by Hosokawa Micron Corporation); Elbow-Jet (manufactured by Nittetsu Mining Co., Ltd.); Dispersion Separator (manufactured by Nippon Pneumatic Mfg. Co., Ltd.); and YM Microcut (manufactured by Yasukawa Shoji K.K.).

In the developing agent according to the exemplary embodiment, addition of an additive such as the foregoing sol-gel derived silica to the toner mother particle can be in general carried out using a mixer such as a V-type blender and a Henschel mixer.

Examples of a screening apparatus which is used for sieving coarse particles or the like include Ultra Sonic (manufactured by Koei Sangyo Co., Ltd.); Resona Sieve and Gyroshifter (all of which manufactured by Tokuju Corporation); Vibrasonic System (manufactured by Dalton Co., Ltd.); Soniclean (manufactured by Shinto Kogyo Kabushiki Kaisha); Turboscreener (manufactured by Turbo Kogyo Co., Ltd.); Microshifter (manufactured by Makino Mfg. Co., Ltd.); and a circular vibrating screen.

Also, the developing agent according to the exemplary embodiment can be prepared by the following manufacturing method.

This manufacturing method includes the steps of mixing a coarsely granulated mixture containing at least a binder resin and a coloring agent with an aqueous medium; subjecting the mixed liquid to mechanical shearing to finely granulate the coarsely granulated mixture; aggregating the fine particle to form an aggregated particle; and optionally fusing the aggregated particle to form a toner particle.

FIGURE is a whole configuration view of a laser printer illustrating an example of an image forming apparatus according to the exemplary embodiment.

In this laser printer, a photoreceptor drum 2 is disposed substantially in the center of a housing 1. This photoreceptor drum 2 is rotated and driven in one direction, namely a clockwise direction in FIGURE by a drive motor 3. A charge section 4 for uniformly charging a photosensitive layer on the surface of the photoreceptor drum 2; a laser scanner unit 5 for irradiating the photosensitive layer charged by this charge section 4 with a laser beam on the basis of image information to form an electrostatic latent image; a developing section 6 for allowing a toner to adhere onto the electrostatic latent image formed on the photosensitive layer to achieve development; a transfer section 7 for transferring an image developed in the developing section 6 onto a transfer paper to be conveyed through a conveying route; a cleaning section 8 for scrapping off the toner from the photoreceptor drum 2; and a destaticizing section 9 for destaticizing the photoreceptor drum 2 are disposed in order as an electrophotographic process mechanism in the surroundings of the photoreceptor drum 2.

The transfer section 7 is located in the underside of the photoreceptor drum 2, and paper is conveyed one sheet by one sheet at a prescribed timing toward the transfer section 7 by the action of a pickup roller 11 from a paper supply cassette 10 provided in one side part of the housing 1.

After a toner image of the photoreceptor drum 2 is transferred by the transfer section 7, the paper to be conveyed is destaticized by a destaticizing section 12 and further fixed by a fixing unit 13. Then, the fixed paper is discharged out the housing 1 by paper discharge rollers 14, 14. Here, the drive motor 3 serves as not only a drive source of the photoreceptor drum 2 but a drive source of the paper conveying mechanism.

Furthermore, a fan 15 for releasing heat in the inside of the housing 1 to the outside; a power source apparatus 16; a cover open switch 17 which when the housing 1 is separated upward and downward, detects that, thereby turning off the power; and the like are provided within the housing 1.

The exemplary embodiments are specifically described below with reference to the following Examples, but it should not be construed that the exemplary embodiments are limited thereto.

First of all, various evaluation methods used in the exemplary embodiments are shown below.

Chargeability

Continuous paper supply of 200,000 sheets of A4-size paper with a printing ratio of 8% was carried out using commercially available e-studio 4520c (manufactured by Toshiba Tec Corporation), and the chargeability was decided according to the following contents. Sampling of the developing agent was carried out at intervals of 10,000 sheets and 15 times in total. When the developing agent was measured using E-Spart Analyzer, the case where the number of times the number % of reverse charge exceeded 2% was not more than 4 times out of 15 in total was evaluated as “good”, whereas the case where it exceeded 5 times was evaluated as “poor”.

Toner Scattering (Long Life)

When an original with a printing ratio of 8.0% was copied on 20,000 sheets of A4-size paper using commercially available e-studio 4520c (manufactured by Toshiba Tec Corporation), the case where contamination such as falling of toner to be caused due to toner scattering was not confirmed on an image was evaluated as “good”, whereas the case where it was confirmed was evaluated as “poor”.

Low-Temperature Fixability

In a modified fixing system of commercially available e-studio 4520c (manufactured by Toshiba Tec Corporation), a fixing temperature was set to 140° C., and a solid image was obtained on ten sheets. The case where offset or image separation to be caused due to unfixing did not occur even slightly on the ten sheets was evaluated as “good”, whereas the case where offset or image separation occurred even slightly was evaluated as “poor”.

### Example 1

Polyester resin (softening point Tm: 100 to 120° C., glass transition temperature Tg: 54 to 60° C.): 85 parts by weight

Crystalline polyester resin (softening point Tm: 100 to 120° C.): 5 parts by weight

Ester wax: 3 parts by weight

Coloring agent (MA-100): 6 parts by weight

Charge control agent (polysaccharide compound containing Al and Mg): 1 part by weight

The foregoing materials were mixed in a Henschel mixer and then melt kneaded by a twin-screw extruder. The obtained melt kneaded material was cooled, then coarsely pulverized by a hammer mill and subsequently finely pulverized and classified using a jet pulverizer, thereby obtaining a toner particle having a volume average diameter of 5.5 μm and a toner softening point Tm of 105° C.

3.0 parts by weight of a sol-gel derived silica fine particle having an average primary particle diameter of 50 nm and an average circularity of 0.95 was added to and mixed with 100 parts by weight of this toner particle by a Henschel mixture, thereby manufacturing a toner.

An existence ratio (%) of the sol-gel derived silica fine particle on the toner particle was 90%.

A volume average particle diameter of the toner was 5.5 μm.

7 parts by weight of the obtained toner was mixed with 100 parts by weight of a ferrite carrier having a silicone resin coated on the surface thereof and having an average particle diameter of 40 μm, and the mixture was stirred in a Turbula mixer, thereby obtaining a developing agent.

The obtained developing agent was set in a modified machine of a full-color copier e—studio 4520c (manufactured by Toshiba Tec Corporation), a fixing temperature was set to 130° C., and a solid image with a toner adhesion amount of 1.6 mg/cm² was printed while allowing ten sheets to pass therethrough, thereby confirming whether or not offset occurred. As a result, it could be confirmed that offset did not occur. Furthermore, chargeability was good, and image contamination to be caused due to toner scattering, or the like was not observed. The obtained evaluation results are summarized in the following Table 1.

Incidentally, the circularity and the softening point Tm were determined using the following apparatus under the following measurement conditions.

Circularity

With respect to the silica fine particle, an image with a magnification of 50,000 times was taken using a scanning electron microscope (SEM), manufactured by Carl Zeiss, and the image was determined for the circularity by an image analysis software Image-Pro Plus, manufactured by Media Cybernetics, Inc.

Toner Softening Point Tm

A sample is weighed in an amount of from 1.45 to 1.5 g using a flow tester (CFT-500D Type, manufactured by Shimadzu Corporation), molded by a pressurizer and installed within a flow tester cylinder. The measurement is carried out by a temperature elevation method under measurement conditions of a temperature elevation rate of 2.5° C./min, a die hole diameter of 1.0 mm, a die length of 1.0 mm, a test weight of 10 kgf and an air pressure of 0.4 MPa. A temperature at which the position of stroke is present at an intermediate position between a softening start point and an outflow end point is defined as the softening point Tm.

### Example 2

Polyester resin (softening point Tm: 100 to 120° C., Tg: 54 to 60° C.): 85 parts by weight

Crystalline polyester resin (softening point Tm: 100 to 120° C.): 0 part by weight

Ester wax: 8 parts by weight

Coloring agent (MA-100): 6 parts by weight

Charge control agent (polysaccharide compound containing Al and Mg): 1 part by weight

The foregoing materials were prepared in the same manner as that in Example 1, thereby obtaining a toner particle having a volume average diameter of 7.0 μm and a toner softening point Tm of 110° C.

1.0 part by weight of a sol-gel derived silica fine particle compound having an average primary particle diameter of 65 nm and an average circularity of 0.90, 2.0 parts by weight of hydrophobic silica having an average primary particle diameter of 20 nm and 0.5 parts by weight of hydrophobic titanium oxide having an average primary particle diameter of 15 nm as additives were added to and mixed with 100 parts by weight of this toner particle by a Henschel mixture, thereby manufacturing a toner.

An existence ratio (%) of the additives having a minor axis of the primary particle diameter in the range of from 30 nm to 70 nm on the surface of the toner particle was 80%.

Furthermore, a developing agent was prepared in the same manner as that in Example 1, followed by the same evaluation.

As a result, it could be confirmed that offset did not occur. Furthermore, chargeability was good, and image contamination to be caused due to toner scattering, or the like was not observed. The obtained evaluation results are shown in Table 1.

### Example 3

Polyester resin (softening point Tm: 100 to 120° C., Tg: 54 to 60° C.): 78 parts by weight

Crystalline polyester resin (softening point Tm: 100 to 120° C.): 10 parts by weight

Ester wax: 5 parts by weight

Coloring agent (MA-100): 6 parts by weight

Charge control agent (polysaccharide compound containing Al and Mg): 1 part by weight

The foregoing materials were prepared in the same manner as that in Example 1, thereby obtaining a toner particle having a volume average diameter of 6 μm and a toner softening point Tm of 95° C.

2.5 parts by weight of a sol-gel derived silica fine particle compound having an average primary particle diameter of 60 nm and an average circularity of 0.94 and 0.5 parts by weight of hydrophobic titanium oxide having an average primary particle diameter of 15 nm were added to and mixed with 100 parts by weight of this toner particle by a Henschel mixture, thereby manufacturing a toner.

An existence ratio (%) of the additives having a minor axis of the primary particle diameter in the range of from 30 nm to 70 nm on the surface of the toner particle was 85%.

Furthermore, a developing agent was prepared in the same manner as that in Example 1, followed by the same evaluation.

As a result, it could be confirmed that offset did not occur. Furthermore, chargeability was good, and image contamination to be caused due to toner scattering, or the like was not observed. The obtained evaluation results are summarized in the following Table 1.

### Example 4

Polyester resin (softening point Tm: 100 to 120° C., Tg: 54 to 60° C.): 83 parts by weight Crystalline polyester resin (softening point Tm: 100 to 120° C.): 5 parts by weight

Ester wax: 5 parts by weight

Coloring agent (MA-100): 6 parts by weight

Charge control agent (metal-containing salicylic acid derivative): 1 part by weight

The foregoing materials were mixed in a Henschel mixer and then melt kneaded by a twin-screw extruder. The obtained melt kneaded material was cooled, then coarsely pulverized by a hammer mill and subsequently further pulverized using a pulverizer, manufactured by Hosokawa Micron Corporation, thereby obtaining a medium pulverized particle having a volume average particle diameter of 58 μm. 30 parts by weight of the obtained medium pulverized particle, 1 part by weight of sodium dodecylbenzenesulfonate (NEOPELLEX G-15) as an anionic surfactant, 1 part by weight of triethylamine as an amine compound and 68 parts by weight of ion-exchanged water were stirred by a homogenizer, manufactured by IKA, thereby obtaining Mixed Liquid 1.

Subsequently, the obtained Mixed Liquid 1 was charged in NANO-MIZER(YSNM-2000AR, manufactured by Yoshida Kikai Co., Ltd., to which a heating system was add) in which the heating system temperature was set to 120° C., and treated repeatedly three times under a treatment pressure of 150 MPa. After cooling, a volume average particle diameter of the obtained colored fine particle was measured by SALD7000 (manufactured by Shimadzu Corporation), and as a result, it was found to be 0.7 μm. A pH of the fine particle dispersion liquid was 8.2.

Subsequently, the dispersion liquid was diluted such that a solids content of the colored fine particle was 18%, to which was then added dropwise 0.1 M hydrochloric acid, thereby adjusting the pH. The dispersion liquid was controlled to a temperature of 30° C. When the pH reached 7.0, the particle diameter was measured, and as a result, it was found to be 0.85 μm. Furthermore, 0.1 M hydrochloric acid was added dropwise, and when a ξ potential of the fine particle reached −30 mV, the dropwise addition was finished. At that time, the pH was 3.9.

Subsequently, the foregoing dispersion liquid was subjected to temperature elevation to 80° C. at a rate of 10° C./min while stirring with a paddle blade (at 500 rpm) and then kept at 80° C. for one hour. After cooling, the dispersion liquid was allowed to stand overnight, and the state of a supernatant was observed. As a result, the supernatant was transparent, and any unaggregated particle was not observed. Also, the volume average particle diameter was measured, and as a result, it was found to be 5.5 μm, and any coarse particle of 20 μm or more was not observed. Thereafter, the resultant was dried by a vacuum dryer until the water content reached not more than 0.8% by weight, thereby obtaining a toner particle having a volume average particle diameter of 5 μm and a toner softening point Tm of 95° C.

2.0 parts by weight of a sol-gel derived silica fine particle compound having an average primary particle diameter of 60 nm and an average circularity of 0.96, 1.0 part by weight of hydrophobic silica having an average primary particle diameter of 20 nm and 1.0 part by weight of hydrophobic titanium oxide having an average primary particle diameter of 15 nm were added to and mixed with 100 parts by weight of this toner particle by a Henschel mixture, thereby manufacturing a toner. Furthermore, a developing agent was prepared in the same manner as that in Example 1, followed by the same evaluation.

As a result, it could be confirmed that offset did not occur. Furthermore, chargeability was good, and image contamination to be caused due to toner scattering, or the like was not observed. The obtained evaluation results are summarized in the following Table 1.

### Comparative Example 1

Polyester resin (softening point Tm: 100 to 120° C., Tg: 54 to 60° C.): 85 parts by weight

Crystalline polyester resin (softening point Tm: 100 to 120° C.): 5 parts by weight

Ester wax: 3 parts by weight

Coloring agent (MA-100): 6 parts by weight

Charge control agent (polysaccharide compound containing Al and Mg): 1 part by weight

The foregoing materials were prepared in the same manner as that in Example 1, thereby obtaining a toner particle having a volume average diameter of 5.5 m and a toner softening point Tm of 105° C.

3.5 parts by weight of a fused silica fine particle compound having an average primary particle diameter of 50 nm and an average circularity of 0.6 was added to and mixed with 100 parts by weight of this toner particle by a Henschel mixture, thereby manufacturing a toner.

An existence ratio (%) of the additive having a minor axis of the primary particle diameter in the range of from 30 nm to 70 nm on the surface of the toner particle could not be measured because the additive aggregated.

Furthermore, a developing agent was prepared in the same manner as that in Example 1, followed by the same evaluation.

As a result, it could be confirmed that offset did not occur.

However, chargeability was not good, and image contamination to be caused due to toner scattering, or the like was observed. The obtained evaluation results are shown in Table 1.

### Comparative Example 2

Polyester resin (softening point Tm: 120 to 140° C., Tg: 56 to 65° C.): 86 parts by weight

Crystalline polyester resin (softening point Tm: 100 to 120° C.): 0 part by weight

Ester wax: 7 parts by weight

Coloring agent (MA-100): 6 parts by weight

Charge control agent (metal-containing salicylic acid derivative): 1 part by weight

The foregoing materials were prepared in the same manner as that in Example 1, thereby obtaining a toner particle having a volume average diameter of 7.0 μm and a toner softening point Tm of 130° C.

1.5 parts by weight of a sol-gel derived silica fine particle compound having an average primary particle diameter of 70 nm and an average circularity of 0.9 and 0.5 parts by weight of hydrophobic titanium oxide having an average primary particle diameter of 15 nm were added to and mixed with 100 parts by weight of this toner particle by a Henschel mixture, thereby manufacturing a toner.

An existence ratio (%) of the additives having a minor axis of the primary particle diameter in the range of from 30 nm to 70 nm on the surface of the toner particle could not be measured because the additives aggregated.

Furthermore, a developing agent was prepared in the same manner as that in Example 1, followed by the same evaluation.

As a result, offset occurred.

Chargeability was good, and image contamination to be caused due to toner scattering, or the like was not observed.

The obtained evaluation results are shown in Table 1.

### Comparative Example 3

Polyester resin (softening point Tm: 120 to 140° C., Tg: 56 to 65° C.): 86 parts by weight

Crystalline polyester resin (softening point Tm: 100 to 120° C.): 2 parts by weight

Ester wax: 5 parts by weight

Coloring agent (MA-100): 6 parts by weight

Charge control agent (polysaccharide compound containing Al and Mg): 1 part by weight

The foregoing materials were prepared in the same manner as that in Example 1, thereby obtaining a toner particle having a volume average diameter of 6.5 μm and a toner softening point Tm of 140° C. 1.5 parts by weight of a fused silica fine particle compound having an average primary particle diameter of 40 nm and an average circularity of 0.5, 1.0 part by weight of hydrophobic silica having an average primary particle diameter of 30 nm and 0.5 parts by weight of hydrophobic titanium oxide having an average primary particle diameter of 20 nm were added to and mixed with 100 parts by weight of this toner particle by a Henschel mixture, thereby manufacturing a toner.

An existence ratio (%) of the additives having a minor axis of the primary particle diameter in the range of from 30 nm to 70 nm on the surface of the toner particle could not be measured because the additives aggregated.

Furthermore, a developing agent was prepared in the same manner as that in Example 1, followed by the same evaluation.

As a result, offset occurred. Also, chargeability was not good, and image contamination to be caused due to toner scattering, or the like was observed.

The evaluation results are shown in the following Table 1.

TABLE 1

| | | Silica fine particle | | | Toner | | | Toner |
|---|---|---|---|---|---|---|---|---|
| | Tm of | | Addition | | particle | Low- | | scattering (in- |
| | toner | | amount | Average | diameter | temperature | Charge | machine |
| | (° C.) | Type | (wt %) | circularity | D50 (μm) | fixability | ability | contamination) |
| Example 1 | 105 | A | 3.0 | 0.95 | 5.5 | Good | Good | Good |
| Example 2 | 110 | A | 1.0 | 0.90 | 7.0 | Good | Good | Good |
| Example 3 | 95 | A | 2.5 | 0.94 | 6.0 | Good | Good | Good |
| Example 4 | 95 | A | 2.0 | 0.96 | 5.5 | Good | Good | Good |
| Comparative | 105 | B | 3.5 | 0.60 | 5.5 | Good | Poor | Poor |
| Example 1 | | | | | | | | |
| Comparative | 130 | A | 1.5 | 0.90 | 7.0 | Poor | Good | Good |
| Example 2 | | | | | | | | |
| Comparative | 140 | B | 0.5 | 0.50 | 6.5 | Poor | Poor | Poor |
| Example 3 | | | | | | | | |

In Table 1, Type A expresses a sol-gel derived silica fine particle, and Type B expresses a fuse silica fine particle.

According to the exemplary embodiments, if a medium particle size silica fine particle which is monodispersed and which has a high circularity is added to a toner particle using a binder resin having a low melting point, it is possible to reveal quick startup properties of charge and to make both low-temperature fixation and high image quality compatible with each other. It may be considered that this is caused due to the matter that even if a charge site of the toner surface becomes non-uniform, in view of the fact that the monodispersed medium particle size fine particle uniformly covers the toner surface, and coupled with its high circularity, quick startup of charge is realized. Also, in the medium particle size silica fine particle having a high circularity, when combined with a toner particle using a high-melting point binder resin, an adhesion onto the toner surface is small, so that there was often found the case where the charged amount distribution becomes non-uniform in a long life. However, when combined with a low-temperature fixing toner having a low viscosity, since immobilization properly proceeds, a good adhesion is obtained, and it becomes possible to realize a long life more than ever. Incidentally, if the particle size of the medium particle size silica fine particle is more uniform, an effect for improving chargeability becomes conspicuous. This is because if the particle size is non-uniform, just a part of large particle size silica fine particles comes into contact with a carrier, or small particle size silica particle is easy to incorporate between large particle size silicas, whereby the medium particle size silica fine particle does not effectively function.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A developing agent comprising
toner particles containing a binder resin and a coloring agent; and
additives added onto the surface of the toner particle, containing a silica fine particle having an average circularity of 0.90 or more, and including an additive having a minor axis a of a primary particle diameter falling within the range of from 30 nm to 70 nm in an existence ratio of 70% or more.

2. The developing agent according to claim 1, wherein an addition amount of the silica fine particle is from 0.1 to 3.0% by weight relative to the total weight of the toner particle.

3. The developing agent according to claim 1, wherein the developing agent has a softening point of from 90 to 110° C.

4. The developing agent according to claim 1, wherein the developing agent has a volume average particle diameter of from 4.0 to 10.0 μm.

5. The developing agent according to claim 1, wherein the silica fine particle is hydrophobilized.

6. The developing agent according to claim 1, wherein the additives further contain an inorganic oxide fine particle other than the silica fine particle.

7. The developing agent according to claim 6, wherein the inorganic oxide fine particle is hydrophobilized.

8. An image forming apparatus comprising
a developing section accommodating a developing agent including a toner particle containing a binder resin and a coloring agent, and additives added onto the surface of the toner particle and containing a silica fine particle having an average circularity of 0.90 or more, and including an additive having a minor axis a of a primary particle diameter falling within the range of from 30 nm to 70 nm in an existence ratio of 70% or more;
an image supporting material for allowing the developing agent to adhere thereto to form a developing agent image; and
a transfer section for transferring the developing agent image onto a transfer medium.

9. The apparatus according to claim 8, wherein an addition amount of the silica fine particle is from 0.1 to 3.0% by weight relative to the total weight of the toner particle.

10. The apparatus according to claim 8, wherein the developing agent has a softening point of from 90 to 110° C.

11. The apparatus according to claim 8, wherein the developing agent has a volume average particle diameter of from 4.0 to 10.0 μm.

12. The apparatus according to claim 8, wherein the silica fine particle is hydrophobilized.

13. The apparatus according to claim 8, wherein the additives further contain an inorganic oxide fine particle other than the silica fine particle.

14. The apparatus according to claim 13, wherein the inorganic oxide fine particle is hydrophobilized.
